(19) United States
(12) Patent Application Publication
(10) Pub. No.: US 2007/0162198 A1
(43) Pub. Date: Jul. 12, 2007

(54) Signalling device and method for railway vehicles

(75) Inventor: Antonin Starck, Lasne (BE)

Correspondence Address: SUGHRUE MION, PLLC, 2100 PENNSYLVANIA AVENUE, N.W., SUITE 800, WASHINGTON, DC, 20037, US

(73) Assignee: ALSTOM BELGIUM S.A.

(21) Appl. No.: 11/238,088

(22) Filed: Sep. 29, 2005

(30) Foreign Application Priority Data
Sep. 30, 2004 (EP) 04447217.3

(51) Int. Cl. G05D 1/00

(52) U.S. Cl. 701/19

(57) ABSTRACT

The present invention is related to a signalling device to obtain signalling related data in a vehicle, whereby the signalling device is arranged to be stored in the vehicle and comprising a database, comprising at least information on the position of virtual beacons on a reference grid, and localisation means to locate the vehicle within the reference grid.

### FIELD OF THE INVENTION

The present invention is related to a device and method for replacing the data transmission between on the one hand beacons placed alongside the track and on the other hand, trains running on the track.

### STATE OF THE ART

Railway signalling currently uses beacons placed alongside the track for sending signalling related data from the ground to the train. There are different types of technology for the existing beacons-train communications. One of these technologies is known under the name EUROBALISE®.

Within the EUROBALISE® technology, one distinguishes two possible uses of these beacons. The beacon is either used solely to transmit pre-encoded information and thus invariable over time, or else, in addition to the pre-encoded information, the beacon also transmits information that varies over time and whose variation is controlled by an encoder linked to the beacon. In both cases, these beacons are installed at pre-determined locations in function of the signalling network and according to the performance required by the application.

As used at present, e.g. in the ERTMS/ETCS signalling system, the beacons transmit information that provides for the following functions:
localisation of the train within a reference grid relative to these beacons,
protection of cross-communications with beacons installed along parallel tracks,
detection of the direction of the train's movement in regard of the track,
possibility of verifying the train's route with the points.

In document EP-B-0644519 an arrangement is disclosed for determining the passage of a mobile unit (e.g. a road transport information system) past a virtual beacon. A beacon location table is used that can be placed centrally within the area or in a respective mobile unit. A central master beacon location table is provided as well. The arrangement further comprises an external position determining system, typically a GPS system. Other aspects of this system are disclosed in EP-B-0644517 and EP-B-0644518.

### AIMS OF THE INVENTION

The present invention aims to provide a signalling device that allows to obtain and to process signalling related data in a vehicle. It further relates to a method for obtaining such data.

### SUMMARY OF THE INVENTION

The present invention relates to a signalling device to obtain signalling related data in a vehicle. The signalling device is arranged to be stored in the vehicle and comprises
a database, comprising at least information on the position of virtual beacons on a reference grid, and
localisation means to locate the vehicle within the reference grid.

In an advantageous embodiment the database further comprises information on the position of real beacons on the reference grid.

In a preferred embodiment the signalling device further comprises means for determining the position of the vehicle with respect to the position of one of the beacons.

Preferably the database further comprises beacon-vehicle data related to the position.

In an advantageous embodiment the beacon-vehicle data related to the position (at least) comprises a beacon identification and the beacon position.

Said vehicle preferably is a train.

In a second object the invention relates to a method for obtaining signalling related data in a vehicle provided with a device as previously described, comprising the steps of
monitoring the location of the vehicle,
locating it within the reference grid by means of the localisation means, and
determining the position of the next beacon within the reference grid using information from the database.

Advantageously the method further comprises the step of determining the position of the vehicle with respect to the position of one of the beacons.

In an alternative embodiment the method further comprises the step of checking whether the vehicle's position corresponds to the position of a beacon stored in the database.

Preferably the method further comprises the step of sending data from the database, when the vehicle's position corresponds to the position of a beacon stored in the database.

### SHORT DESCRIPTION OF THE DRAWINGS

FIG. 1 represents a block scheme of a device according to the invention.

### DETAILED DESCRIPTION OF THE INVENTION

The present invention describes a device and procedure allowing to provide the signalling system functions, partly supported by the data transmission between the above-described beacons and the trains, in three different scenarios:
no beacons whatsoever are installed in the area in which one intends to use the signalling system,
beacons are only installed at certain places within the area in which one intends to use the signalling system, the number of beacons being significantly lower than that required by the same signalling application which does not use the solution according to the invention,
trains are used that don't carry beacon readers in areas equipped with such beacons.

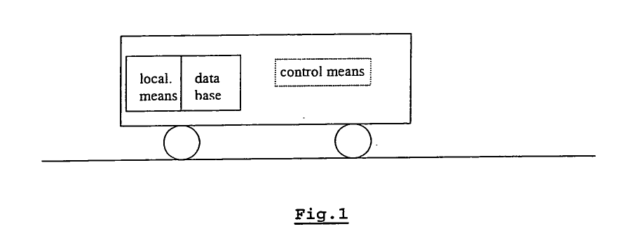

The procedure is based on the following principles. The equipment, which is to be carried on the train, contains a database holding data sets [position of the beacon on the track, beacon-train data corresponding to this position] (see FIG. 1). The database comprises at least information on the virtual beacons, but may as well comprise data related to real beacons. Said beacon-train data corresponding to the position may comprise a beacon identification and the beacon position. Furthermore, the signalling device stored in the train comprises a localisation function that allows to locate the train within a reference grid identical to that used by the database to indicate the position of the beacon along the track. This is performed with a safety level equivalent to that of the procedure using real beacons. Said localisation function may be based on a satellite positioning method, such as that described in WO02/03094.

The signalling device also comprises control means, which permanently verifies whether the current position of the train is equal to or has passed (in the train's direction of travel) the position of a beacon that has been stored in the database. If this condition is met, the device will provide the application with the same data as normally transmitted by the beacon to the train, whereby in this case the message issues from the corresponding database stored in this signalling device.

In this way, the signalling application will be provided with the required data, by a so-called virtual beacon, in an identical way as in a scenario with real beacons. This has the advantage that an application designed to use data provided by real beacons can be provided with data from virtual beacons where such real beacons are not present, or that a train without beacon reader can use the signalling application.

The solution according to the invention can advantageously be applied in a scenario with a limited number of real beacons installed on the track. Beacons are only installed at certain places within the area in which one intends to use the signalling system, the number of beacons being significantly lower than that required by the same signalling application. Applying virtual beacons can so result in considerable cost savings.

1. Signalling device to obtain signalling related data in a vehicle, said signalling device being arranged to be stored in said vehicle and comprising
a database, comprising at least information on the position of virtual beacons on a reference grid, and
localisation means to locate said vehicle within said reference grid.

2. Device as in claim 1, wherein said database further comprises information on the position of real beacons on said reference grid.

3. Device as in claim 1, further comprising means for determining the position of said vehicle with respect to the position of one of said beacons.

4. Device as in claim 1, wherein said database further comprises beacon-vehicle data related to said position.

5. Device as in claim 4, wherein said beacon-vehicle data related to said position comprises beacon identification and beacon position.

6. Device as in claim 1, wherein said vehicle is a train.

7. Method for obtaining signalling related data in a vehicle provided with a device as in claim 1, said method comprising the steps of:
monitoring the location of said vehicle,
locating it within said reference grid by means of said localisation means, and
determining the position of the next beacon within said reference grid using information from said database.

8. Method as in claim 7, further comprising the step of determining the position of said vehicle with respect to said position of one of said beacons.

9. Method as in claim 7, further comprising the step of checking whether said vehicle's position corresponds to the position of a beacon stored in said database.

10. Method as in claim 9, further comprising the step of sending data from said database, when said vehicle's position corresponds to the position of a beacon stored in said database.
